(19) United States
(12) Patent Application Publication
(10) Pub. No.: US 2015/0098348 A1
(43) Pub. Date: Apr. 9, 2015

(54) WIRELESS COMMUNICATON DEVICE, WIRELESS COMMUNICATION SYSTEM, WIRELESS COMMUNICATION METHOD, AND WIRELESS APPARATUS

(71) Applicant: KABUSHIKI KAISHA TOSHIBA, Minato-ku (JP)

(72) Inventors: Koji OGURA, Tachikawa (JP); Tomoko Adachi, Kawasaki (JP)

(73) Assignee: KABUSHIKI KAISHA TOSHIBA, Minato-ku (JP)

(21) Appl. No.: 14/488,758

(22) Filed: Sep. 17, 2014

(30) Foreign Application Priority Data
Oct. 9, 2013 (JP) 2013-212052

(51) Int. Cl. H04W 76/06; H04W 24/08; H04W 76/02; H04W 4/00

(52) U.S. Cl. CPC H04W 76/06; H04W 4/008; H04W 24/08; H04W 76/028
USPC 370/252

(57) ABSTRACT

A wireless communication device has processing circuitry. The processing circuitry measures intensity of a signal received from a communication apparatus, senses whether the intensity is equal to or greater than a first threshold value, performs a connection process with the communication apparatus, performs data communication with the communication apparatus through close-range wireless communication, updates the first threshold value to the intensity and make a first sensor proceed with its process, senses whether a difference between the intensity and the first threshold value becomes larger than a second threshold value, and disconnects the communication with the communication apparatus when being sensed that the difference is larger than the second threshold value.

### CROSS REFERENCE TO RELATED APPLICATIONS

This application is based upon and claims the benefit of priority from the prior Japanese Patent Application No. 2013-212052, filed on Oct. 9, 2013, the entire contents of which are incorporated herein by reference.

### FIELD

Embodiments of the present invention relate to a wireless communication device, a wireless communication system, a wireless communication method, and a wireless apparatus for performing close-range wireless communication at high speed.

### BACKGROUND

Noncontact close-range wireless communication as typified by RFID, Felica (registered trademark), and NFC (Near field communication) has been widely spreading. Techniques for transmitting/receiving large-volume data at high data-rate have been also being developed. As an example of such noncontact close-range wireless communication, a microwave close-range wireless communication system such as TransferJet (registered trademark) is now in practical use (see patent documents 1, 2, and 3).

To transmit and receive larger volume of data, it is desirable to use a higher frequency band for the wireless communication. Thus, it is studied to utilize millimeter waves of 30 GHz or higher in the close-range wireless communication to transmit/receive large-volume data at high speed. Using millimeter waves means utilizing an antenna for transmitting and receiving signals through the radiated electromagnetic field, instead of utilizing a coupler as in TransferJet, which may make the communication distance longer than TransferJet.

In an existing microwave close-range wireless communication system such as NFC and TransferJet, wireless communication is performed only when a mobile terminal held by a user is placed over a fixed communication device. Thus, when performing millimeter-wave communication instead of TransferJet etc., it is desirable to provide the user with a usability similar to that of TransferJet. Otherwise, the user will get confused.

### BRIEF DESCRIPTION OF THE DRAWINGS

FIG. 1 is a block diagram showing a schematic structure of a wireless communication system 1 according to the present invention.

FIG. 2 is a block diagram showing an example of the internal structure of a fixed communication device 2 or a mobile communication terminal 3.

FIG. 3(a)-(c) are diagrams each showing a movement trajectory of the mobile communication terminal 3 with an arrow when a user holding the mobile communication terminal 3 places the mobile communication terminal 3 over a reader 2b of the fixed communication device 2.

FIG. 4 is a diagram showing operation timing and received signal intensity in the wireless communication system 1 according to a first embodiment.

FIG. 5 is a flow chart showing the processing operation performed by the wireless communication system 1 according to the first embodiment.

FIG. 6 is a diagram showing an example where a gain of +7 dB is added to the received signal intensity due to variation in components.

FIG. 7 is a block diagram showing a schematic structure of the wireless communication system 1 according to a second embodiment.

FIG. 8 is a flow chart showing the processing operation performed by the wireless communication system 1 according to the second embodiment.

FIG. 9 is a block diagram showing a schematic structure of the wireless communication system 1 according to a third embodiment.

FIG. 10 is a diagram showing operation timing and received signal intensity in the wireless communication system 1 according to the third embodiment.

FIG. 11 is a block diagram showing a schematic structure of the wireless communication system 1 according to a fourth embodiment.

FIG. 12 is a diagram showing a concrete example of the MCS set by link adaptation module 24.

FIG. 13 is a diagram showing an example of the link adaptation according to the fourth embodiment.

FIG. 14 is a diagram showing a first modification example of the link adaptation according to the fourth embodiment.

FIG. 15 is a diagram showing a second modification example of the link adaptation according to the fourth embodiment.

FIG. 16 (a)-(c) are diagrams each explaining a summary of a fifth embodiment.

FIG. 17 is a diagram showing the operation timing and received signal intensity when a plurality of mobile communication terminals 3 sequentially perform close-range wireless communication with the fixed communication device 2.

FIG. 18 is a diagram showing an example of disconnecting communication prior to the arrival at Point C.

FIG. 19 is a block diagram of a wireless communication device 4 obtained by adding a buffer 33 to the configuration of FIG. 2.

FIG. 20 is a block diagram of the wireless communication device 4 obtained by adding a bus 34, an external interface 35, and a processor 36 to the configuration of FIG. 19.

FIG. 21 is a block diagram of the wireless communication device 4 obtained by adding a clock generator 37 to the configuration of FIG. 2.

### DETAILED DESCRIPTION

According to one embodiment, a wireless communication device has processing circuitry. The processing circuitry:

measures intensity of a signal received from a communication apparatus;

senses whether the intensity is equal to or greater than a first threshold value;

performs a connection process with the communication apparatus when being sensed that the intensity is equal to or greater than the first threshold value, or when a predetermined signal is received from the communication apparatus;

performs, after the connection process is completed, data communication with the communication apparatus through close-range wireless communication;

updates the first threshold value to the intensity and make a first sensor proceed with its process, when the intensity becomes equal to or greater than the first threshold value after the data communication is started;

senses whether a difference between the intensity and the first threshold value becomes larger than a second threshold value, due to a reduction in the intensity after the data communication is started; and

disconnects the communication with the communication apparatus when being sensed that the difference is larger than the second threshold value.

### First Embodiment

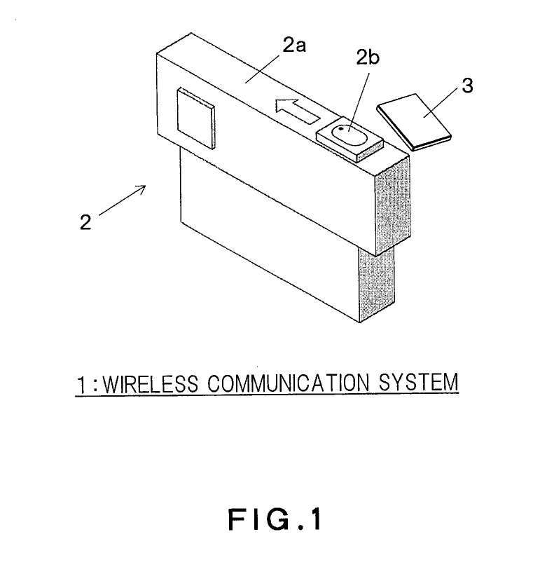

FIG. 1 is a block diagram showing a schematic structure of a wireless communication system 1 according to a first embodiment. The wireless communication system 1 of FIG. 1 has a fixed communication device 2 installed at a fixed location, and a mobile communication terminal 3 capable of performing close-range wireless communication with the fixed communication device 2.

As shown in FIG. 1, the fixed communication device 2 is e.g. a wireless gate 2a provided as a ticket wicket in the station. The wireless gate 2a of FIG. 1 has, on its top surface, a reader 2b. The top face of the reader 2b clearly indicates the position over which the mobile communication terminal 3 should be placed. Note that the fixed communication device 2 should not be necessarily limited to the wireless gate 2a, and may be a data provider kiosk which transfers specific data to the mobile communication terminal 3 when the mobile communication terminal 3 held by a user is placed over the data provider kiosk.

The mobile communication terminal 3 held by the user may be an IC card, or may be a component incorporated into cellular phone, smartphone, tablet, etc.

The fixed communication device 2 and mobile communication terminal 3 transmit and receive large-volume data at high speed through close-range wireless communication utilizing millimeter waves in 30 to 70 GHz band. The wireless communication system 1 according to the present embodiment is characterized in that the wireless communication is performed within a communication distance of 3 to 4 cm and cannot be performed beyond a communication distance of 10 cm, in order to obtain a usability similar to that of an existing microwave close-range wireless communication system such as TransferJet.

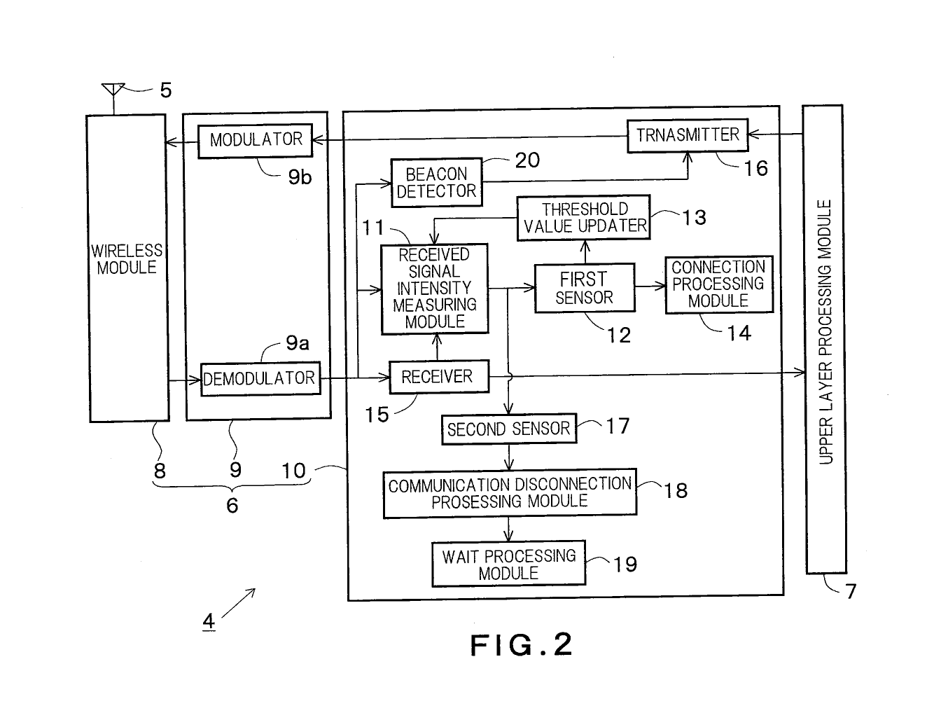

FIG. 2 is a block diagram showing an example of the internal structure of the fixed communication device 2 or the mobile communication terminal 3. At least one of the fixed communication device 2 and mobile communication terminal 3 may have the internal structure of FIG. 2. Thus, hereinafter, a device having the internal structure of FIG. 2 is referred to as a wireless communication device 4, and a communication partner which transmits/receives large-volume data to/from the wireless communication device 4 at high speed through close-range wireless communication using millimeter waves is referred to as a communication partner device (communication apparatus).

The wireless communication device 4 of FIG. 2 has an antenna 5, a wireless transceiver section 6, and an upper layer processing module 7. The wireless transceiver section 6 has a wireless module 8, a modulation/demodulation module 9, and a MAC processor 10.

The wireless module 8 converts a radio signal received by the antenna 5 into a baseband signal, and converts a baseband signal to be transmitted from the antenna 5 into a radio signal. In the present embodiment, the antenna 5 transmits/receives a millimeter wave radio signal at 60 GHz for example.

The modulation/demodulation module 9 has a demodulator 9a which demodulates a baseband signal corresponding to the radio signal received by the antenna 5, and a modulator 9b which modulate a baseband signal corresponding to the radio signal to be transmitted from the antenna 5.

The MAC processor 10 analyzes the header of a MAC frame included in the baseband signal, for example. The upper layer processing module 7 processes a packet in a layer upper than the MAC layer.

The MAC processor 10 has a received signal intensity measuring module 11, a first sensor 12, a threshold value updater 13, a connection processing module 14, a receiver 15, a transmitter 16, a second sensor 17, a communication disconnection processing module 18, a wait processing module 19, and a beacon detector 20.

The received signal intensity measuring module 11 measures intensity of a signal received from the communication apparatus. More concretely, the received signal intensity measuring module 11 measures the average of the received signal intensity based on time averaging.

The first sensor 12 senses whether the received signal intensity measured by the received signal intensity measuring module 11 is equal to or greater than a first threshold value.

The connection processing module 14 performs a connection process with the communication apparatus when the first sensor 12 senses that the received signal intensity is equal to or greater than the first threshold value, or when a predetermined signal (e.g., beacon signal) is received from the communication apparatus.

The transmitter 16 and receiver 15 transmit/receive data to/from the communication apparatus through close-range wireless communication, after the connection process by the connection processing module 14 is completed. The receiver 15 and transmitter 16 correspond to a data communication module.

When the received signal intensity becomes equal to or greater than the first threshold value after the data communication by the data communication modules 15 and 16 is started, the threshold value updater 13 updates the first threshold value to the received signal intensity, and then the first sensor 12 again performs its process.

The second sensor 17 senses whether the difference between the received signal intensity and the first threshold value becomes larger than a second threshold value, due to a gradual reduction in the received signal intensity measured by the received signal intensity measuring module 11 after the data communication by the data communication modules 15 and 16 is started.

The communication disconnection processing module 18 disconnects the communication with the communication apparatus when the second sensor 17 senses that the difference is larger than the second threshold value.

The wait processing module 19 measures the time which has elapsed since the communication disconnection processing module 18 disconnected the communication with the communication apparatus (e.g., fixed communication device 2), and prohibits newly performing the connection process until the elapsed time exceeds a predetermined period of time.

The beacon detector 20 detects a beacon signal periodically transmitted from the communication apparatus. When the beacon signal is detected, the wireless communication device 4 of FIG. 2 transmits a connection request signal to the communication apparatus.

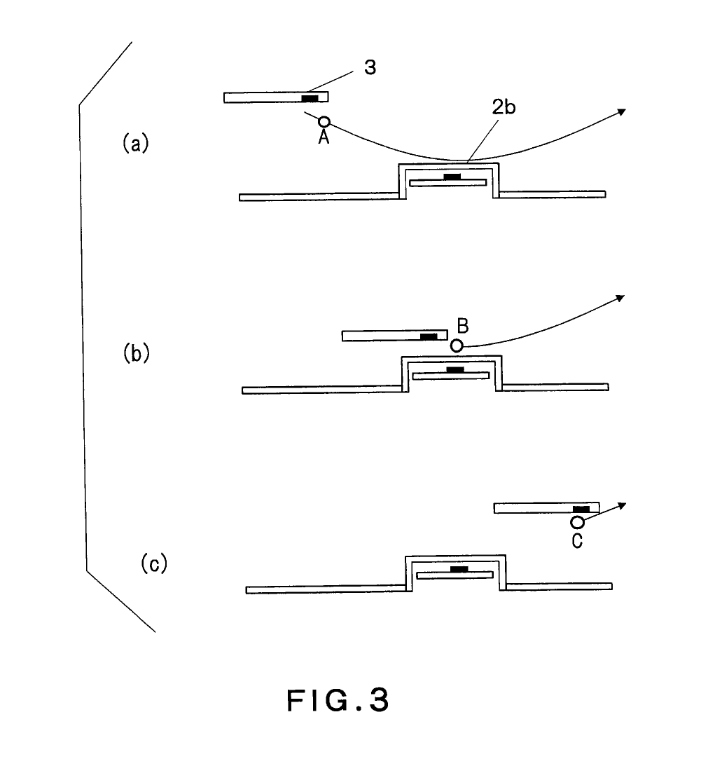

FIG. 3 is diagrams each showing a movement trajectory of the mobile communication terminal 3 with an arrow when a user holding the mobile communication terminal 3 places the mobile communication terminal 3 over the reader 2b of the fixed communication device 2. The mobile communication terminal 3 passes through Point A and gradually approaches the reader 2b as shown in FIG. 3(a), passes through nearest Point B as shown in FIG. 3(b), and gradually moves away from the reader 2b to pass through Point C as shown in FIG. 3(c).

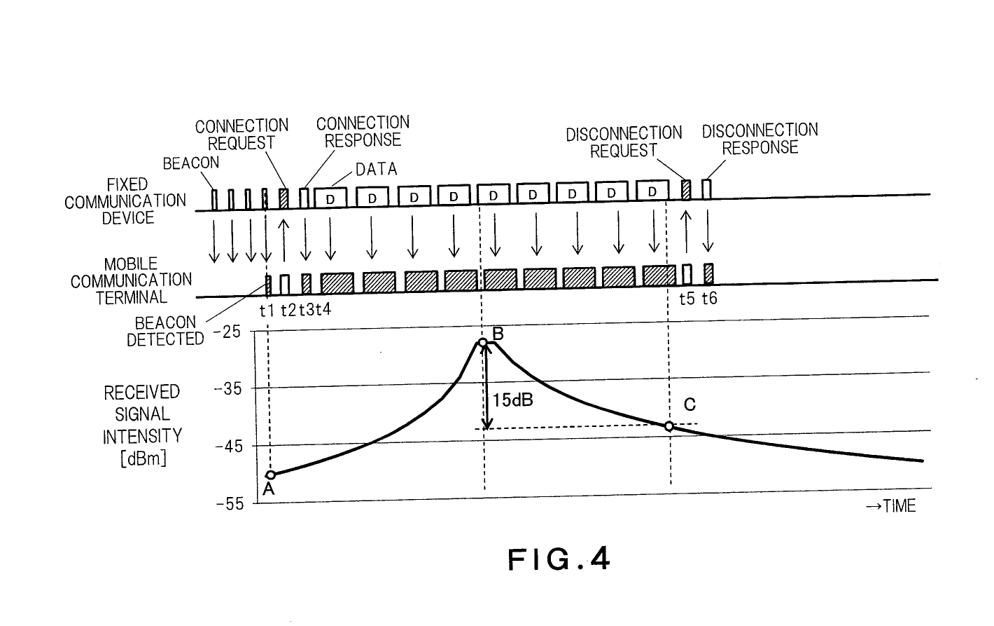

FIG. 4 is a diagram showing operation timing and received signal intensity in the wireless communication system 1 according to a first embodiment. In FIG. 4, the horizontal axis represents time.

The fixed communication device 2 periodically transmits a beacon signal to the outside regardless of whether the mobile communication terminal 3 exists nearby. The mobile communication terminal 3 senses the beacon signal when reaching Point A (Time t1), and transmits a connection request signal to the fixed communication device 2 (Time t2). Upon receiving the connection request signal, the fixed communication device 2 transmits a connection response signal to the mobile communication terminal 3 (Time t3). Upon receiving this connection response signal, the mobile communication terminal 3 performs data communication with the fixed communication device 2 (Time t4 and thereafter).

As shown in the graph of FIG. 4, the received signal intensity gradually increases as the mobile communication terminal 3 moves from Point A to Point B, and becomes the maximum at Point B. The received signal intensity gradually decreases as the mobile communication terminal 3 moves away from Point B to approach Point C.

When the mobile communication terminal 3 arrives at Point C, the mobile communication terminal 3 transmits a disconnection request signal to the fixed communication device (Time t5). Upon receiving the disconnection request signal, the fixed communication device 2 transmits a disconnection response signal to the mobile communication terminal 3 (Time t6).

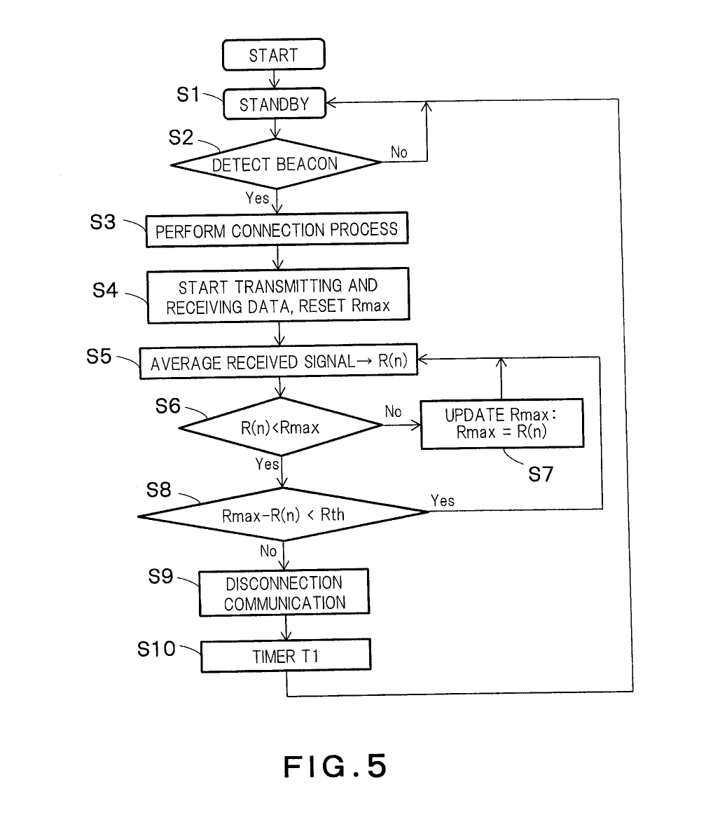

FIG. 5 is a flow chart showing the processing operation performed by the wireless communication system 1 according to the first embodiment. This flow chart shows the processing operation performed before and after the user holding the mobile communication terminal 3 while moving places the mobile communication terminal 3 over the reader 2b of the fixed communication device 2.

The fixed communication device 2 is in a standby mode where the fixed communication device 2 periodically transmits a beacon signal (Step S1). On the other hand, the mobile communication terminal 3 held by the user always senses whether the beacon signal is received (Step S2). Steps S1 and S2 are repeated until the mobile communication terminal 3 senses the beacon signal.

When the user starts placing the mobile communication terminal 3 over the fixed communication device 2, the mobile communication terminal 3 senses the beacon signal, and starts a connection process (Step S3). Here, as shown in FIG. 4, the mobile communication terminal 3 transmits a connection request signal to the fixed communication device 2, and the fixed communication device 2, upon receiving this connection request signal, transmits a connection response signal to the mobile communication terminal 3.

After the connection process of Step S3 is completed, the fixed communication device 2 transmits/receives desired data to/from the mobile communication terminal 3 (Step S4). For example, the fixed communication device 2 transmits large-volume data to the mobile communication terminal 3. The received signal intensity measuring module 11 in the mobile communication terminal 3 measures received signal intensity while the data is being received. More concretely, the received signal intensity measuring module 11 calculates signal strength R(n) by averaging the signal strength within a predetermined period of time, based on time averaging (Step S5). When the period for the time averaging is short, stable signal strength cannot be obtained due to the influence of signal propagation.

The present embodiment intends to obtain a usability similar to that of an existing microwave close-range wireless communication system such as TransferJet, and thus the period for the time averaging should be set to prevent the user from recognizing a difference in the usability. Accordingly, it is desirable that the period for the time averaging is set between 200 microseconds and 100 milliseconds. Here, the period for the time averaging is set to 200 microseconds.

At Step S4, while data is transmitted and received, the threshold value updater 13 initializes first threshold value Rmax previously stored (Step S4). Then, the first sensor 12 senses whether received signal intensity R(n) measured by the received signal intensity measuring module 11 is less than the first threshold value Rmax (Step S6). If the received signal intensity is equal to or greater than the first threshold value Rmax, the threshold value updater 13 updates the first threshold value Rmax to the received signal intensity R(n) (Step S7), and Steps S5 and S6 are subsequently performed.

In this way, the first threshold value Rmax is updated to the latest received signal intensity as the received signal intensity gradually increases. For example, in the case of FIG. 4, the received signal intensity is −50 dBm at Point A and becomes −28 dBm at Point B, and the first threshold value Rmax is finally updated to −28 dBm.

If it is sensed that the received signal intensity is less than the first threshold value Rmax at Step S6, the second sensor 17 senses whether the difference between the first threshold value Rmax and the received signal intensity is less than the second threshold value Rth (Step S8). If the difference is less than the second threshold value Rth, Steps S5 to S8 are subsequently performed. If the difference is equal to or greater than the second threshold value Rth, the communication disconnection processing module 18 disconnects the communication with the fixed communication device (Step S9).

In the case of FIG. 4, the first threshold value Rmax becomes finally −28 dBm, and when the second sensor 17 senses that the difference between the first threshold value and the received signal intensity at Point C exceeds the second threshold value Rth (e.g., 15 dBm), the communication disconnection processing module 18 disconnects the communication with the communication apparatus.

If the fixed communication device 2 returns to the standby mode of Step S1 immediately after the communication is disconnected at Step S9, the mobile communication terminal 3 promptly performs Step S3 and subsequent steps to be connected to the fixed communication device 2 again, which is because the received signal intensity at Point C is higher than the received signal intensity (−50 dBm) which enables the beacon detector 20 to sense the beacon signal.

Accordingly, after the communication is disconnected at Step S9, the fixed communication device 2 waits for a predetermined period of time using e.g. a timer (Step S10), and then shifts to the standby mode of Step S1.

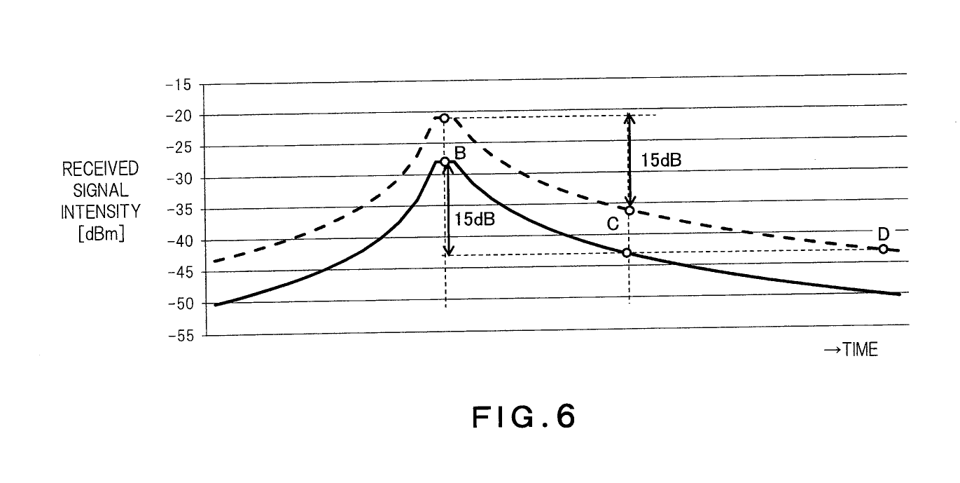

At least a part of the wireless communication system 1 of FIG. 1 can be made using an IC chip or a discrete part, but manufacturing variability in the IC chip and discrete part may cause a difference in electric characteristics. For example, FIG. 6 shows an example where a gain of +7 dB is added to the received signal intensity due to variation in components (see a broken line curve of FIG. 6). In FIG. 6, as the comparison between the broken line curve and a solid line curve showing ideal characteristics shows, the difference between the maximum received signal intensity at Point B and the received signal intensity observed at Point C is hardly influenced by the manufacturing variability, and changes depending on the communication distance. Therefore, similarly to the second sensor 17 at Step S8 of FIG. 5, the difference between the maximum received signal intensity and the current received signal intensity is compared to the second threshold value Rth to disconnect the communication depending on the communication distance, without being influenced by the manufacturing variability in the IC chip etc.

As stated above, In the first embodiment, upon receiving the beacon signal periodically transmitted from the fixed communication device 2, the mobile communication terminal 3 starts the connection process with the fixed communication device 2. The mobile communication terminal 3 monitors the received signal intensity to detect the maximum received signal intensity until the received signal intensity becomes the maximum, and forcibly disconnects the communication after the difference between the maximum received signal intensity and the current received signal intensity becomes equal to or greater than the second threshold value Rth. This makes it possible to perform the communication with the fixed communication device 2 only within a communication range similar to that of an existing microwave close-range wireless method such as TransferJet, which means that a usability similar to that of the existing microwave close-range wireless method can be obtained.

As stated above, in the present embodiment, the communication distance is identified based on the difference between the maximum received signal intensity and the current received signal intensity, and the communication is forcibly disconnected using the identified communication distance. For example, when disconnecting the communication around 100 m (e.g., between 90 and 100 m) in a microwave cellular system, 100 m is only twice the distance of 50 m, which leads to a difference of 6 dB in the received signal intensity, considering the square-root law. Further, when comparing 80 m with 100 m, the difference in the received signal intensity is 2 dB or smaller. Accordingly, such a distance difference makes it impossible to disconnect the communication with high accuracy.

In the case of a close-range wireless communication system which performs wireless communication only when the mobile communication terminal is placed over the reader, the wireless communication is permitted only within a communication distance of about 1 to 3 cm. In this case, 10 cm is 10 times the communication distance of 1 cm, which leads to a difference of 20 dB in the received signal intensity. In the present embodiment, the communication is disconnected utilizing a difference in the received signal intensity obtained when the distance ratio is about 1:10. The large difference in the received signal makes it possible to identify the communication distance with high accuracy.

### Second Embodiment

A second embodiment to be explained below is characterized in disconnecting the communication not in the MAC layer but in a layer upper than the MAC layer, and establishing the connection again after disconnecting the communication.

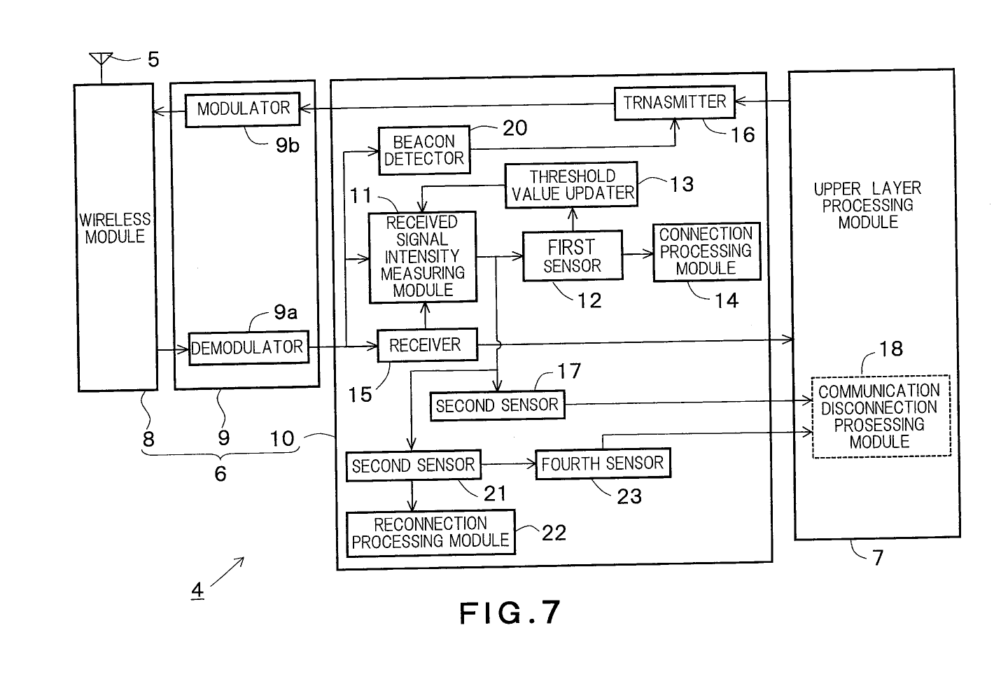

FIG. 7 is a block diagram showing a schematic structure of the wireless communication system 1 according to the second embodiment.

The wireless communication system 1 of FIG. 7 is different from FIG. 1 in that the communication disconnection processing module 18 is provided not in the MAC processor 10 but in the upper layer processing module 7, and that the upper layer processing module 7 further has a third sensor 21, a reconnection processing module 22, and a fourth sensor 23.

The third sensor 21 senses whether the received signal intensity measured by the received signal intensity measuring module 11 after the communication with the communication apparatus is disconnected by the communication disconnection processing module 18 becomes larger than the received signal intensity at the time of the communication disconnection by a third threshold value or greater.

The reconnection processing module 22 performs the connection process with the communication apparatus again when the third sensor 21 senses that the difference between the received signal intensity measured after the communication with the communication apparatus is disconnected and the received signal intensity at the time of the communication disconnection is larger than the third threshold value.

The fourth sensor 23 senses whether the time which has elapsed since the communication session was disconnected exceeds a predetermined period of time, when the third sensor 21 senses that the difference between the received signal intensity measured after the communication with the communication apparatus is disconnected and the received signal intensity at the time of the communication disconnection is equal to or smaller than the third threshold value. When the fourth sensor 23 senses that the elapsed time exceeds the predetermined period of time, the communication disconnection processing module 18 disconnects layers lower than the session layer.

The communication disconnection processing module 18 disconnects the session layer serving as an upper layer, while keeping the connection between the fixed communication device 2 and mobile communication terminal 3 in the MAC layer and subsequent lower layers. Generally, the MAC layer is composed of hardware parts such as an IC chip. Introducing the function of disconnecting the communication to the hardware parts leads to uniformed processing, operation and less scalability. On the other hand, the session layer upper than the MAC layer is generally composed of software. In the session layer, other elements for judgment such as application attributes and remaining battery level can be employed in addition to the received signal, to perform the communication disconnection process more finely. That is, disconnecting the session layer by software makes it possible to perform a flexible and scalable communication disconnection process.

Note that “session disconnection” is performed to interrupt, stop, or suspend the session, since the reconnection process is performed after that. That is, “session disconnection” is a concept including a temporary stop of data transmission/reception in the session layer.

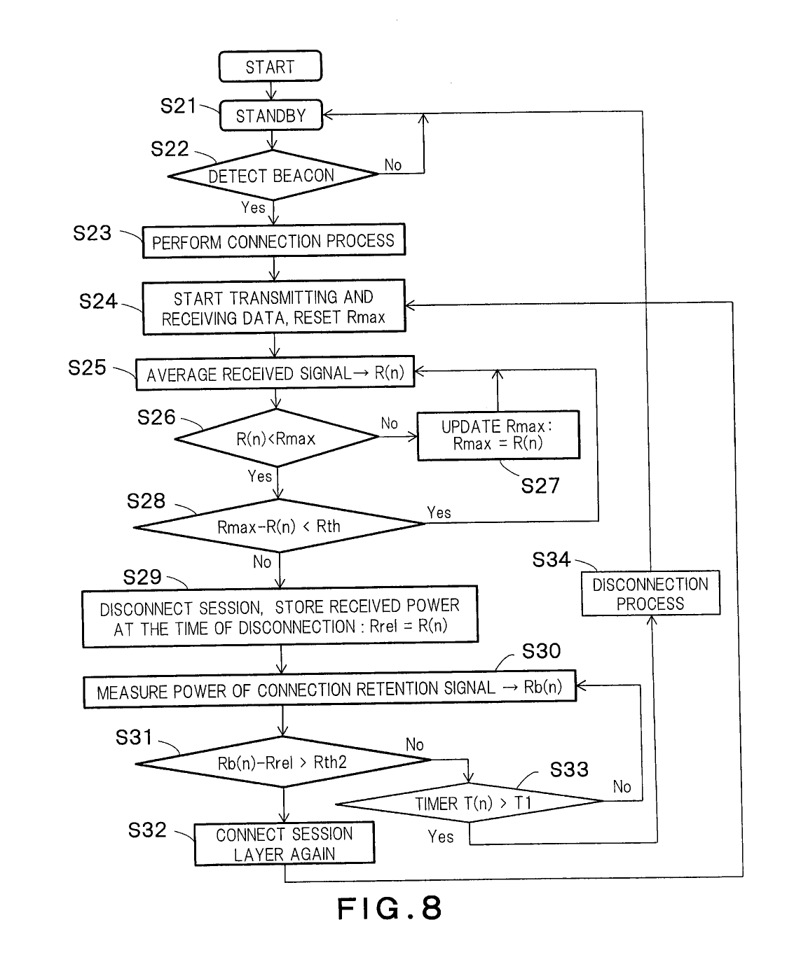

FIG. 8 is a flow chart showing the processing operation performed by the wireless communication system 1 according to the second embodiment. Steps S21 to S28 are similar to Steps S1 to S8 of FIG. 5. If it is sensed that the difference between the first threshold value Rmax and the received signal intensity is equal to or greater than the second threshold value Rth at Step S8, the session layer is disconnected (Step S29), differently from Step S9 of FIG. 5. Then, received signal intensity Rrel at the time of the session layer disconnection is stored.

Although the session layer is disconnected at Step S29, a connection retention signal is periodically transmitted/received to/from the communication apparatus (e.g., fixed communication device 2) in the MAC layer and subsequent lower layers. Thus, received signal intensity Rb(n) of the connection retention signal is measured (Step S30).

Next, the third sensor 21 senses whether the difference between the received signal intensity Rb(n) of the connection retention signal and the received signal intensity at the time of the session layer disconnection stored at Step S29 is larger than a third threshold value Rth2 (Step S31). If the difference is larger than the third threshold value Rth2, the session layer is connected again (Step S32), and Step S24 and subsequent steps are performed. On the other hand, if the difference is equal to or less than the third threshold value Rth2, the fourth sensor 23 senses whether time T(n) which has elapsed since the session layer was disconnected exceeds a predetermined period of time T1 (Step S33). If the time T(n) does not exceed the predetermined period of time T1, Step S30 and subsequent steps are performed. If the time T(n) exceeds the predetermined period of time T1, the communication in the MAC layer and subsequent lower layers is disconnected (Step S34), and the flow returns to Step S21.

In the flow chart of FIG. 8, the connection retention signal is transmitted and received in the MAC layer and subsequent lower layers and the received signal intensity thereof is measured, in order to determine whether the session layer should be connected again. Instead, the mobile communication terminal 3 may return to the standby mode to receive the beacon signal from the fixed communication device 2 and measure the received signal intensity thereof, in order to judge whether the session layer should be connected again.

As stated above, in the second embodiment, the communication is disconnected not in the MAC layer and subsequent lower layers but in the session layer upper than the MAC layer, which makes it possible to implement the disconnection process with software. Thus, conditions of the disconnection process can be controlled more finely.

### Third Embodiment

In the first and second embodiments, the connection process is started when receiving a beacon signal periodically transmitted from the communication apparatus (e.g., fixed communication device 2). A third embodiment to be explained below is characterized in that the connection process is started when the mobile communication terminal 3 receives a connection request signal periodically transmitted from the fixed communication device 2 instead of the beacon signal.

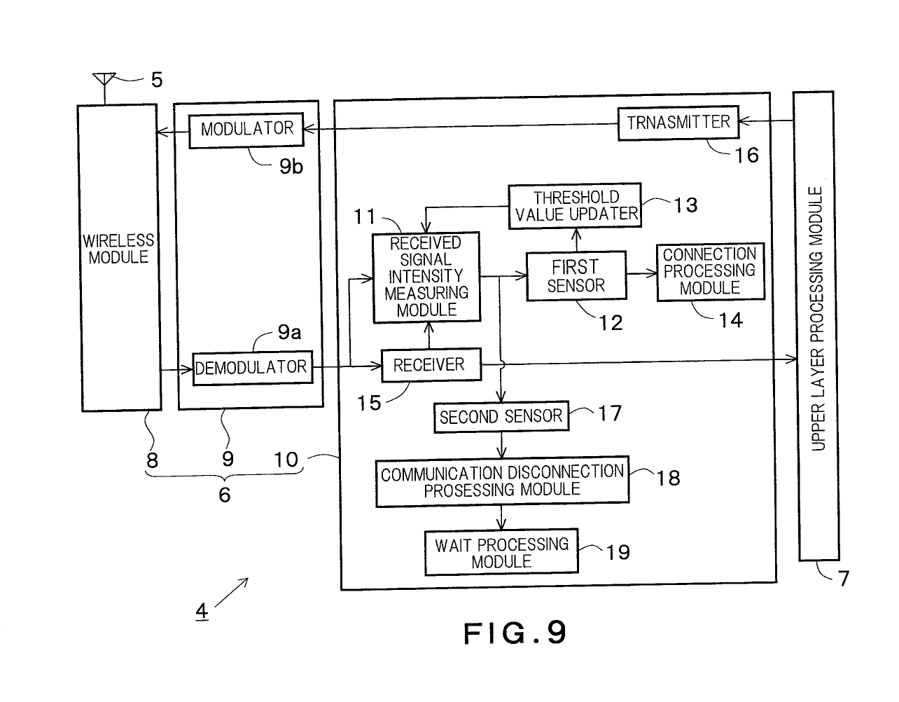

FIG. 9 is a block diagram showing a schematic structure of the wireless communication system 1 according to the third embodiment.

The wireless communication system 1 of FIG. 9 is obtained by omitting the beacon detector 20 from FIG. 2.

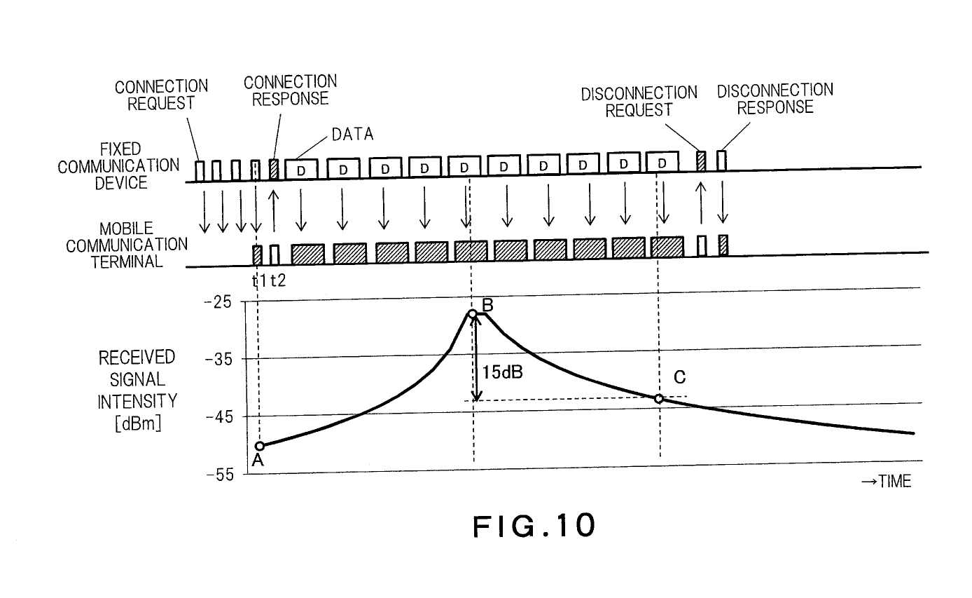

FIG. 10 is a diagram showing operation timing and received signal intensity in the wireless communication system 1 according to the third embodiment. As shown in FIG. 10, the fixed communication device 2 periodically transmits a connection request signal. The mobile communication terminal 3 receives the connection request signal when arriving at Point A (Time t1), and transmits a connection response signal (Time t2). When the fixed communication device 2 receives this connection response signal, data communication is performed between the mobile communication terminal 3 and fixed communication device 2. The processing operation to be performed thereafter is the same as FIG. 4.

As stated above, in the third embodiment, the fixed communication device 2 periodically transmits a connection request signal instead of a beacon signal, and the mobile communication terminal 3, upon receiving the connection request signal, transmits a connection response signal. This makes it possible to quickly complete the connection process and shorten the time required for the connection process, compared to the case where the beacon signal is used.

### Fourth Embodiment

A fourth embodiment to be explained below is characterized in that the wireless communication system 1 has link adaptation functions.

The wireless communication system 1 having the link adaptation functions is known. The link adaptation functions are provided to control transfer speed, encoding ratio, number of repetitions, etc. depending on communication distance, received signal intensity, etc. For example, when the communication distance is long and the received signal intensity is weak, an MCS (Modulation and Coding Scheme) enabling communication with a low S/N ratio is used to reduce transfer speed, increase an encoding ratio, and increase the number of repetitions. As another example, when the communication distance is short and the received signal intensity is strong, the encoding ratio and the number of repetitions are reduced to perform communication with high transfer speed.

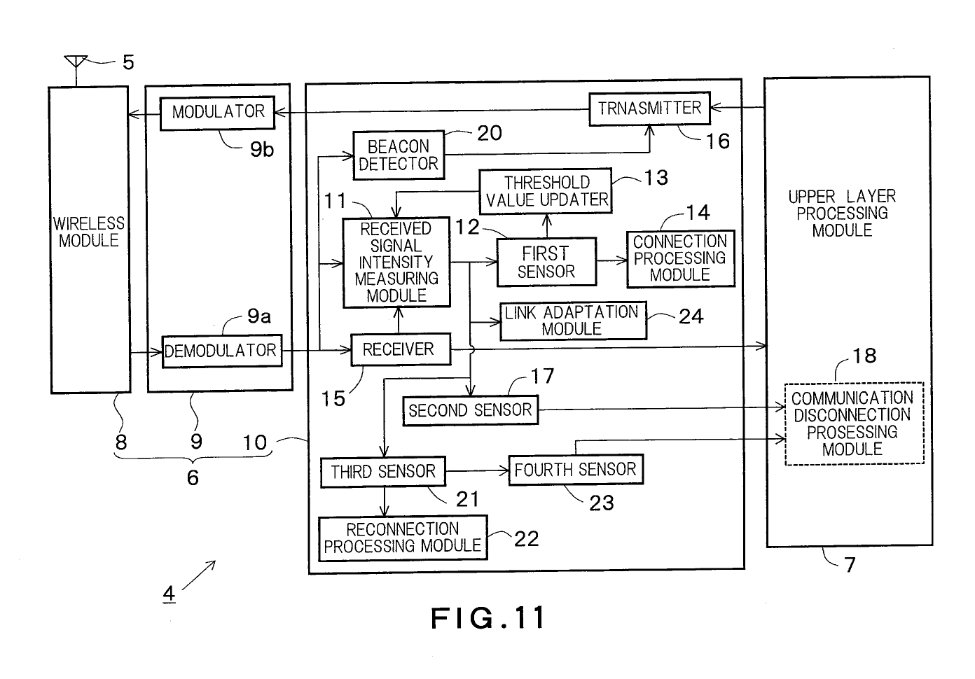

FIG. 11 is a block diagram showing a schematic structure of the wireless communication system 1 according to the fourth embodiment. The wireless communication system 1 of FIG. 11 is obtained by adding a link adaptation module 24 to FIG. 7. The link adaptation module 24 of FIG. 7 adjusts transfer speed, encoding ratio, and number of repetitions, etc. based on the received signal intensity.

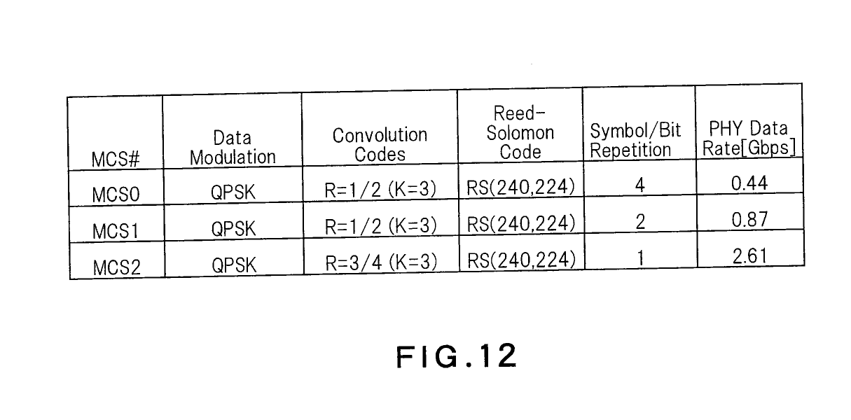

FIG. 12 is a diagram showing a concrete example of the MCS set by the link adaptation module 24. The example of FIG. 12 shows three types of MCSs (MCS0 to 2) each including data concerning modulation method (Data Modulation), convolutional encoding (Convolution Codes), Reed-Solomon encoding, number of repetitions, and PHY transfer rate.

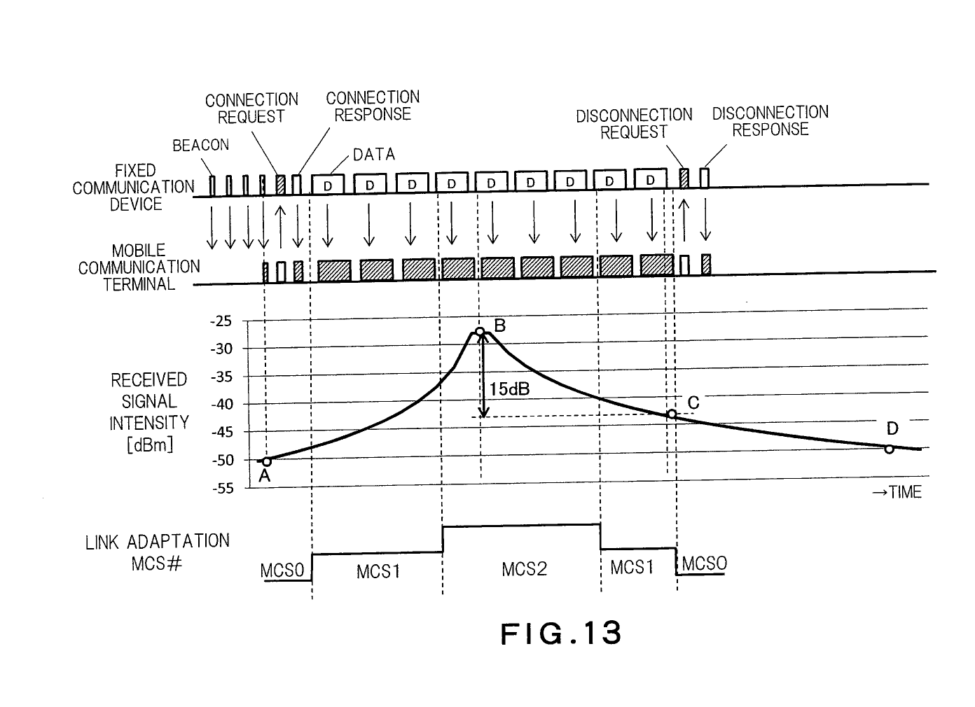

FIG. 13 is a diagram showing an example of a link adaptation according to the fourth embodiment. At Point A, the connection process is performed selecting e.g. MCS0 from FIG. 12, which is because there is a long distance between the fixed communication device 2 and mobile communication terminal 3 and the S/N ratio of the received signal is low. After that, as the distance between the fixed communication device 2 and mobile communication terminal 3 gets shorter, MCS0 is switched to MCS1, and further switched to MCS2. This achieves high-speed transmission. After passing through Point B, the S/N ratio of the received signal gradually becomes lower, and thus MCS2 is switched to MCS1, and further switched to MCS0 after passing through Point C. By selecting MCS0 when the distance between the fixed communication device 2 and mobile communication terminal 3 becomes long, the communication can be continued until reaching Point D.

As stated above, the link adaptation makes it possible to increase the communication distance.

In the fourth embodiment, the link adaptation is employed but the communication is forcibly disconnected when the distance between the fixed communication device 2 and mobile communication terminal 3 reaches a predetermined length.

That is, when the mobile communication terminal 3 arrives at Point C in FIG. 13, the communication is forcibly disconnected by performing Steps S8 and S9 of FIG. 5 or Steps S28 and S29 of FIG. 8, although the communication with the fixed communication device 2 is maintained by the link adaptation.

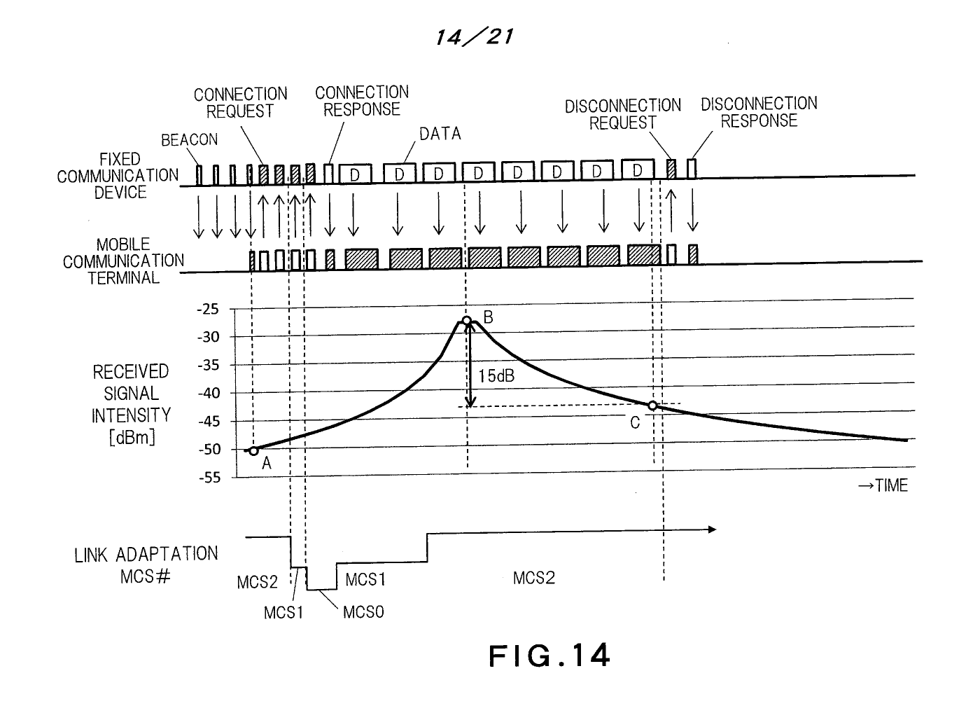

FIG. 14 is a diagram showing a first modification example of the link adaptation according to the fourth embodiment.

FIG. 14 is different from FIG. 13 in a concrete configuration of the link adaptation. In FIG. 14, MCS is switched to a lower level through the link adaptation only immediately after the connection process is started. When the S/N ratio is high in the connection process, MCS at a higher level makes it possible to complete the communication process in a short time. However, a sufficient S/N ratio cannot be obtained around Point A, and thus MCS is switched to a lower level to perform the connection process after the mobile communication terminal 3 passes through Point A. When performing data communication after that, MCS is switched to the maximum MCS2 to perform high-speed data transfer. After that, MCS2 is kept even after the mobile communication terminal 3 passes through Point B. Then, when the mobile communication terminal 3 arrives at Point C, the communication is forcibly disconnected by performing Steps S8 and S9 of FIG. 5 or Steps S28 and S29 of FIG. 8.

When the communication distance gradually becomes longer after becoming the shortest, setting MCS to a lower level makes it possible to perform the data communication in a longer and longer communication distance. However, in the present embodiment, there is no need to set MCS to a lower level after starting the data communication, which is because the present embodiment intends to perform the data communication only within the same communication range as an existing microwave close-range wireless communication system.

Therefore, the link adaptation module 24 adjusts MCS only while the connection process is performed, and keeps the MCS constant after the data communication is started, which means that the processing operation performed by the link adaptation module 24 can be simplified.

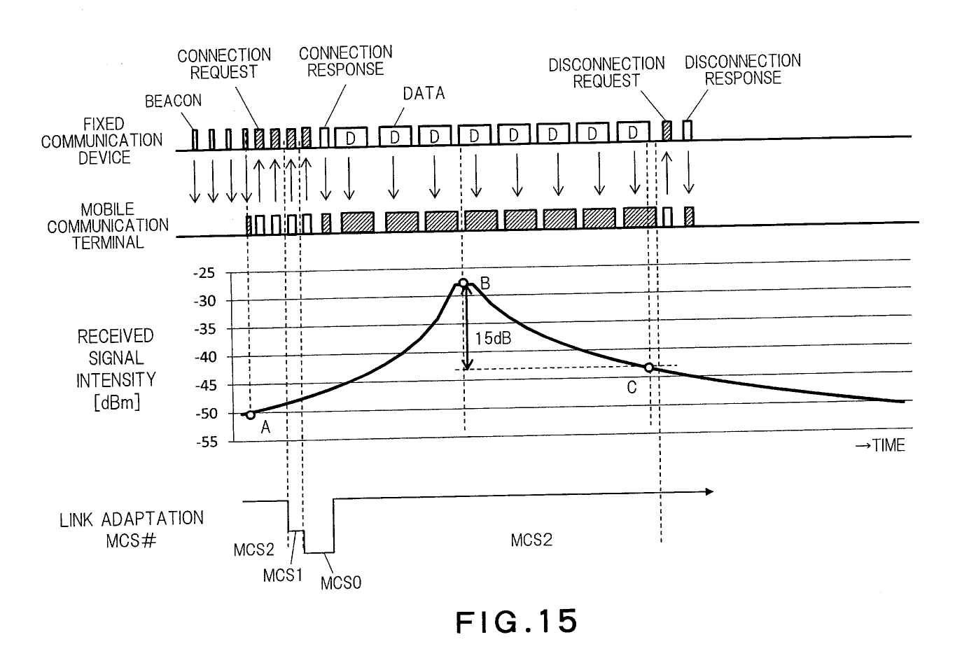

FIG. 15 is a diagram showing a second modification example of the link adaptation according to the fourth embodiment.

In FIG. 15, the link adaptation is performed only within a period since the mobile communication terminal 3 passes through Point A until the connection process is performed between the mobile communication terminal 3 and fixed communication device 2. When the mobile communication terminal 3 is around Point A, the communication distance is still long, and thus the S/N ratio of the received signal is low. Accordingly, the connection process is performed while setting MCS gradually to a lower level (from MCS2 to MCS1, and further to MCS0). After the connection process is completed, MCS is set to the maximum MCS2 to perform data transfer at high speed. MCS2 is kept even after the mobile communication terminal 3 passes through Point B. Then, when the mobile communication terminal 3 arrives at Point C, the communication is forcibly disconnected by performing Steps S8 and S9 of FIG. 5 or Steps S28 and S29 of FIG. 8.

As stated above, in the fourth embodiment, although the link adaptation is performed, the communication is forcibly disconnected at the point when the difference in the received signal intensity exceeds the second threshold value Rth. Thus, there is no need to perform the link adaptation after the data transfer is started, which simplifies the processing operation performed by the link adaptation module 24.

### Fifth Embodiment

A fifth embodiment to be explained below is characterized in that the user can arbitrarily switch between a communication disconnection process using the link adaptation and a communication disconnection process using the magnitude of a difference in the received signal intensity without depending on the link adaptation.

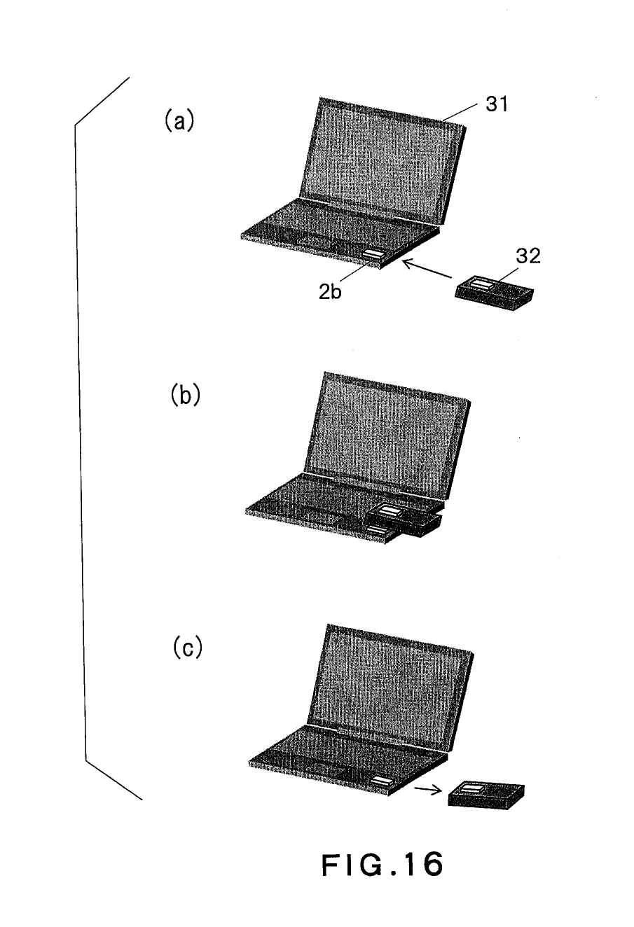

FIG. 16 is a diagram explaining a summary of the fifth embodiment. As shown in FIG. 16(a), the wireless communication system 1 according to the fifth embodiment has a PC 31 serving as the fixed communication device 2, and a mobile memory device 32 serving as the mobile communication terminal 3. The mobile memory device 32 includes a large-volume data storage medium such as a NAND-type flash memory, and performs data communication with the PC 31 through close-range wireless communication.

As a procedure for starting the data communication, the mobile memory device 32 is first placed over the reader 2b of the PC 31, as shown in FIG. 16(b). Upon this, the connection process is performed between the mobile memory device 32 and PC 31, and the OS (operating system) of the PC 31 recognizes the mobile memory device 32 as an external drive. After that, the mobile memory device 32 is placed near the PC 31 to be used as an external drive, as shown in FIG. 16(c).

In the first to fourth embodiments, the communication is forcibly disconnected when the communication distance between the fixed communication device 2 and mobile communication terminal 3 becomes 10 cm or longer, in order to obtain a usability similar to that of an existing microwave close-range wireless communication system. However, in the fifth embodiment, it is not certain that the user places the mobile memory device 32 within a distance of 10 cm from the PC 31 after the connection process between the PC 31 and mobile memory device 32 is completed. If the communication is forcibly disconnected at the point when the distance therebetween exceeds 10 cm, the user is required to place the mobile memory device 32 over the PC 31 again, which deteriorates the usability.

Accordingly, in the present embodiment, MCS (e.g., MCS0) permitting the communication in a longer and longer communication distance can be set using the link adaptation functions, in order that the data communication can be continuously performed even when the user places the mobile memory device 32 10 cm or more away from the PC 31 after the connection process is completed. Further, similarly to the first to fourth embodiments, the process of forcibly disconnecting the communication when the distance between the PC 31 and mobile memory device 32 exceeds 10 cm can be selected as needed. This switch is achieved by using a physical switch for example. Instead, attributes of the mobile communication terminal 3 placed over the wireless communication device 4 mounted on the PC 31 may be read into the PC 31 to identify whether the mobile communication terminal 3 is the mobile memory device 32, so that the PC 31 transmits a signal notifying the mobile memory device 32 that the communication should not be disconnected using a difference in the received signal intensity if the mobile communication terminal 3 is the mobile memory device 32.

As stated above, in the fifth embodiment, after the data communication is started following the completion of the connection process, it is possible to automatically or manually switch between a communication disconnection process using the link adaptation and a communication disconnection process using the magnitude of a difference in the received signal intensity without depending on the link adaptation, as needed, which improves the usability.

### Sixth Embodiment

A sixth embodiment to be explained below is characterized in assuming that a plurality of mobile communication terminals 3 sequentially perform close-range wireless communication with the fixed communication device 2.

When the fixed communication device 2 is the wireless gate 2a for example, it is expected that a plurality of mobile communication terminals 3 are sequentially placed over the reader 2b of the fixed communication device 2. In this case, after one mobile communication terminal 3 is placed over the reader, the communication with the mobile communication terminal 3 must be disconnected quickly. This is because the close-range wireless communication is based on one-on-one communication, which means that the communication with one mobile communication terminal 3 must be disconnected always before establishing the connection to the next mobile communication terminal 3.

The fixed communication device 2 periodically transmits a beacon signal while being connected to one mobile communication terminal 3. This beacon signal may possibly be received by another mobile communication terminal 3. Therefore, while the data communication is still being performed after a certain user places his/her mobile communication terminal 3 (hereinafter referred to as a first mobile communication terminal 3) over the reader 2b of the fixed communication device 2, another user may possibly starts placing his/her mobile communication terminal 3 (hereinafter referred to as a second mobile communication terminal 3) over the same reader 2b.

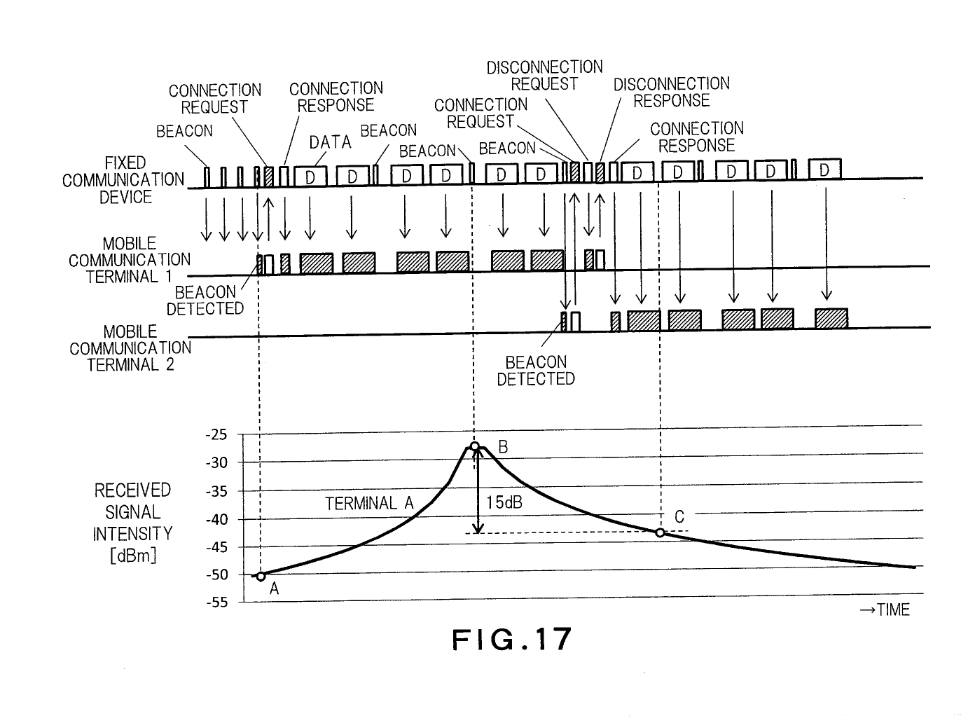

In this case, as shown in FIG. 17, when the second mobile communication terminal 3 senses the beacon signal and transmits a connection request, the fixed communication device 2 gives priority to the connection with the second mobile communication terminal 3, and disconnects the communication with the first mobile communication terminal 3 before the first mobile communication terminal 3 arrives at Point C.

This is because the close-range wireless communication is based on one-on-one communication as stated above, and the communication with the preceding mobile communication terminal 3 must be disconnected always before establishing the connection to the next mobile communication terminal 3. Thus, in this case, the first threshold value Rmax at Step S8 of FIG. 5 is set smaller to disconnect the communication with the first mobile communication terminal 3 before reaching Point C.

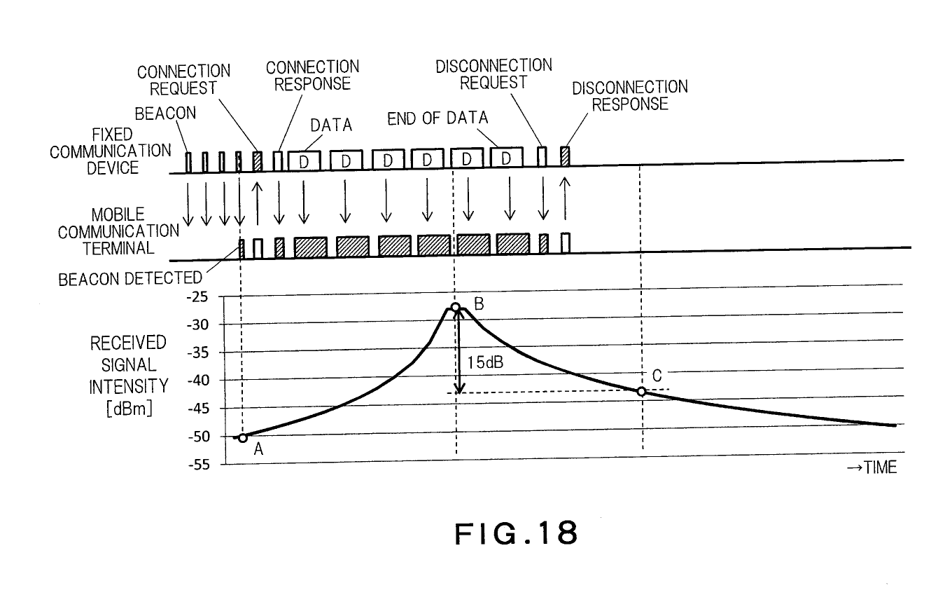

As shown in FIG. 18, it is also possible to disconnect the communication with the fixed communication device 2 at the point when the data transmitted from the fixed communication device 2 is completely received, regardless of whether the next mobile communication terminal 3 exists or not. In the example shown in FIG. 18, the mobile communication terminal 3 transmits a disconnection request signal to the fixed communication device 2 at the point when the mobile communication terminal 3 completes receiving the data from the fixed communication device 2 before arriving at Point C, and the fixed communication device 2, upon receiving this signal, transmits a disconnection response signal to the mobile communication terminal 3 to disconnect the communication. The communication disconnection process as performed in FIG. 18 can be applied to the first to fifth embodiments.

As stated above, in the sixth embodiment, when a plurality of mobile communication terminals 3 are sequentially placed over the fixed communication device 2, the communication with the preceding mobile communication terminal 3 is disconnected at earlier timing to give priority to the connection to the next mobile communication terminal 3. This configuration can be applied to the wireless gate 2a.

### Seventh Embodiment

A seventh embodiment to be explained below is characterized in that a buffer for storing transmitted/received data and a clock generator are provided in the wireless communication device 4 according to the first to sixth embodiments.

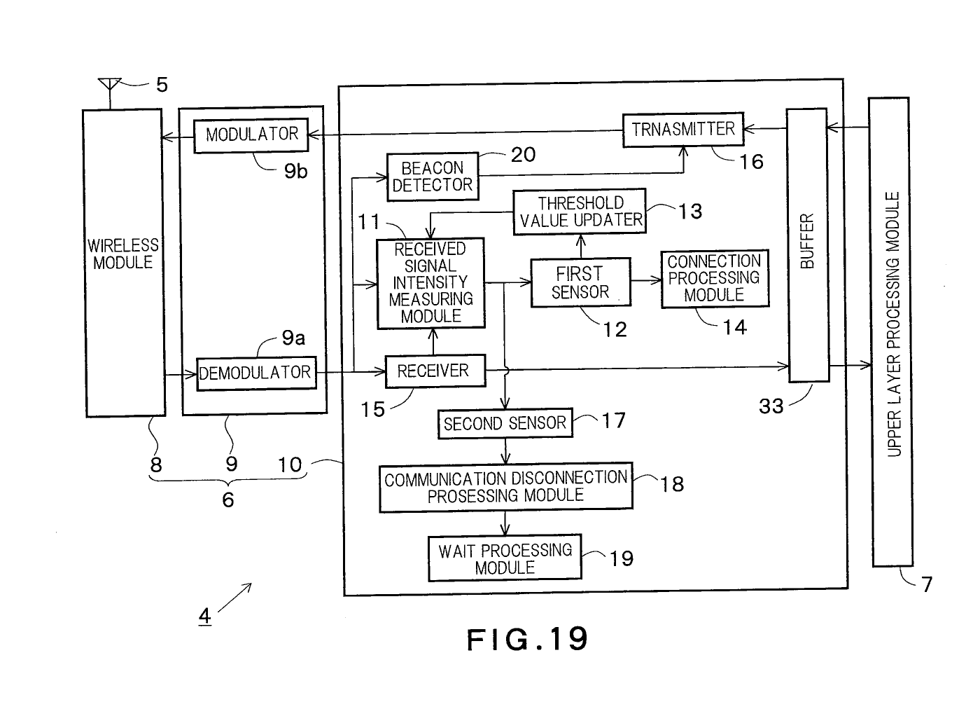

FIG. 19 is a block diagram of the wireless communication device 4 obtained by adding a buffer 33 to the configuration of FIG. 2. The buffer 33 stores data transmitted and received between the mobile communication terminal 3 and the fixed communication device 2 serving as the communication apparatus. This makes it possible to transmit the data again for any reason, and to output the data transmitted to the communication apparatus to the outside, promptly and easily.

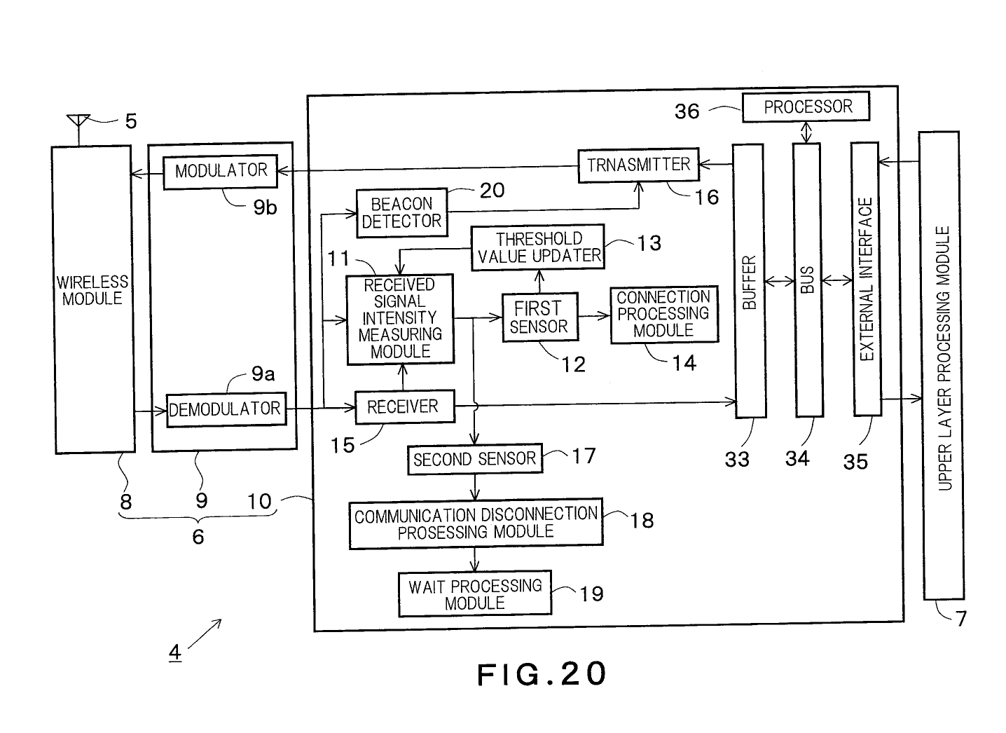

FIG. 20 is a block diagram of the wireless communication device (wireless apparatus) 4 obtained by adding a bus 34, an external interface 35, and a processor 36 to the configuration of FIG. 19. The processor 36 executes firmware. More concretely, the processor 36 carries out data processing related to the wireless communication performed by the wireless communication device of FIG. 19. The external interface 35 can input/output the firmware executed by the processor 36. The bus 34 is connected between the external interface 35 and buffer 33 and can update the firmware executed by the processor 36 by supplying, to the processor 36, the firmware acquired from the outside by the external interface 35 or the firmware received by the receiver 15 and temporarily stored in the buffer (storage) 33. Further, the buffer 33 stores data related to the data processing carried out by the processor 36. This makes it possible to easily change the functions of the wireless communication device 4.

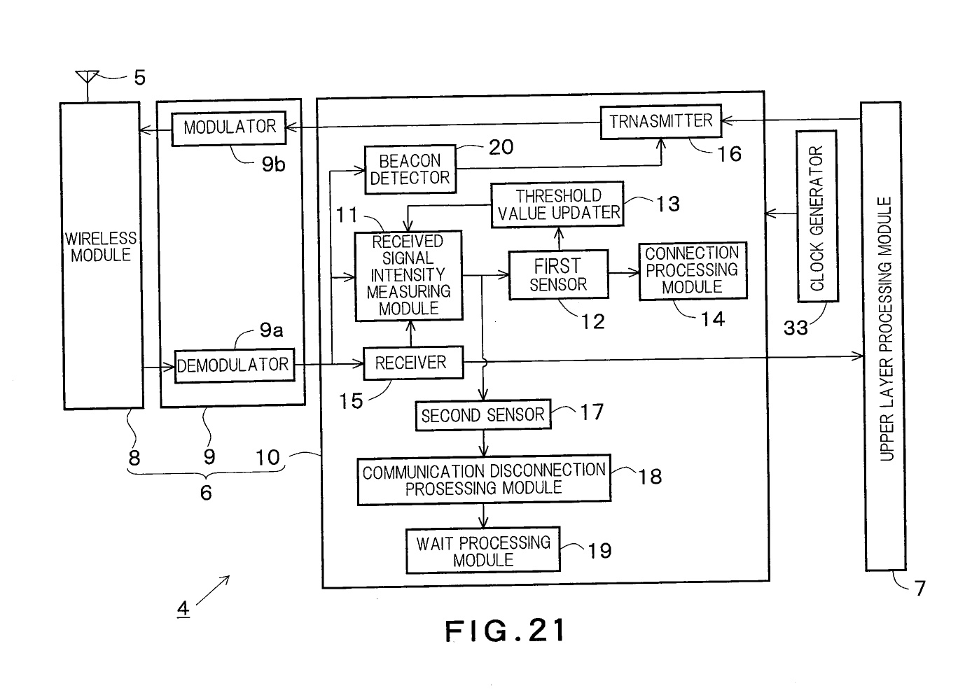

FIG. 21 is a block diagram of a wireless apparatus obtained by adding a clock generator 37 to the wireless communication device 4 of FIG. 2. The clock signal generated by the clock generator 37 of FIG. 21 is outputted to the outside, and also used to synchronize the components in the wireless communication device 4. The clock signal outputted to the outside is supplied to a host device and the communication apparatus, to synchronize the host device and communication apparatus. In this way, each device in the wireless communication system 1 can be synchronized, which prevents a timing gap etc.

### Eighth Embodiment

In the examples shown in the above first to seventh embodiments, the fixed communication device 2 transfers data to the mobile communication terminal 3 after the connection process between the fixed communication device 2 and mobile communication terminal 3 is completed. Instead, the mobile communication terminal 3 may return an ACK signal to the fixed communication device 2 each time the mobile communication terminal 3 receives data. Then, the fixed communication device 2 may measure the received signal intensity of this ACK signal, to sense whether the communication with the mobile communication terminal 3 should be disconnected.

As stated above, at least a part of processing operation performed by the wireless communication device 4 in the first to sixth embodiments may be performed by either the fixed communication device 2 or the mobile communication terminal 3. For example, when one of the fixed communication device 2 and mobile communication terminal 3 connects communication by performing the steps of FIG. 5 or FIG. 8, the wireless communication device 4 may have a connection status notifier for notifying the other that the communication has been disconnected.

At least a portion of functions performed by the above-mentioned wireless communication system 1 may be constituted by at least one of hardware and software. When constituted by software, a program of executing at least a portion of the functions performed by the transmitter 1 and the receiver 2 is stored in a recording media such as a floppy disk or CD-ROM, and is loaded to a computer to execute its program. The recording media is not limited to a portable media such a magnetic disk or an optical disk, but a fixed recording media such as a hard disk drive or a memory may be used to store the program. When constituted by hardware or software, at least a portion of the wireless communication system 1 may be realized by processing circuitry.

The program of executing at least a portion of the functions performed by the wireless communication system 1 may be distributed via a communication line such as Internet. The program may be distributed via a wired line or a wireless line such as Internet at a state of encrypting, modulating or compressing the program, or may be distributed at a state of being stored in the recording media.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A wireless communication device comprising:
processing circuitry comprising:
to measure intensity of a signal received from a communication apparatus;
to sense whether the intensity is equal to or greater than a first threshold value;
to perform a connection process with the communication apparatus when being sensed that the intensity is equal to or greater than the first threshold value, or when a predetermined signal is received from the communication apparatus;
to perform, after the connection process is completed, data communication with the communication apparatus through close-range wireless communication;
to update the first threshold value to the intensity and make a first sensor proceed with its process, when the intensity becomes equal to or greater than the first threshold value after the data communication is started;
to sense whether a difference between the received signal intensity and the first threshold value becomes larger than a second threshold value, due to a reduction in the intensity after the data communication is started; and
to disconnect the communication with the communication apparatus when being sensed that the difference is larger than the second threshold value.

2. The wireless communication device of claim 1,
wherein when the processing circuitry measures the intensity of the signal, the processing circuitry measures the intensity by averaging signal strength of a beacon signal, a connection request signal, or an ACK signal transmitted from the communication apparatus based on time averaging.

3. The wireless communication device of claim 1,
wherein the processing circuitry further comprising:
to measure a time which has elapsed since the communication with the communication apparatus is disconnected, and to prohibit newly performing the connection process until the elapsed time exceeds a predetermined period of time.

4. The wireless communication device of claim 1,
wherein a disconnection process is performed on a session layer when being sensed that the difference is larger than the second threshold value.

5. The wireless communication device of claim 1,
wherein the processing circuitry further comprising:
to sense whether the intensity after the communication with the communication apparatus is disconnected becomes larger than the intensity at the time of the communication disconnection by a third threshold value or greater; and
to perform the connection process with the communication apparatus again when being sensed that the difference between the intensity measured after the communication with the communication apparatus is disconnected and the intensity at the time of the communication disconnection is larger than the third threshold value.

6. The wireless communication device of claim 5,
wherein when the processing circuitry disconnects the communication, the processing circuitry performs a disconnection process on a session layer when being sensed that the difference is larger than the second threshold value, and
the processing circuitry senses whether a time which has elapsed since the disconnection process is performed on the session layer exceeds a predetermined period of time, when being sensed that the difference between the intensity measured after the communication with the communication apparatus is disconnected and the intensity at the time of the communication disconnection is equal to or smaller than the third threshold value, and
when being sensed that the elapsed time exceeds the predetermined period of time, layers lower than the session layer in a communication hierarchy are disconnected.

7. The wireless communication device of claim 1,
wherein the wireless communication device is a portable mobile communication terminal,
the communication apparatus is a fixed communication device installed at a fixed location,
the connection process and the reconnection process are performed with the communication apparatus when the wireless communication device is placed over a predetermined part of the communication apparatus, and
the communication with the communication apparatus is disconnected when the wireless communication device is stopped being placed over the predetermined part of the communication apparatus.

8. The wireless communication device of claim 1,
wherein the wireless communication device is a fixed communication device installed at a fixed location,
the communication apparatus is a portable mobile communication terminal,
the connection process and the reconnection process are performed with the communication apparatus when the communication apparatus is placed over a predetermined part of the wireless communication device, and
the communication with the communication apparatus is disconnected when the communication apparatus is stopped being placed over the predetermined part of the wireless communication device.

9. The wireless communication device of claim 1,
wherein the processing circuitry further comprising:
to notify the communication apparatus that the connection process and the reconnection process are performed with the communication apparatus, and that the communication with the communication apparatus is disconnected.

10. The wireless communication device of claim 1,
wherein the processing circuitry further comprising:
to adjust an MCS (Modulation and Coding Scheme) including a modulation manner and an encoding ratio of the wireless communication, depending on the intensity of the signal received from the communication apparatus, and
to prohibit adjustment of the MCS while the data communication with the communication apparatus is performed after the connection process with the communication apparatus is completed.

11. The wireless communication device of claim 10,
wherein the processing circuitry employs an MCS for a higher transfer speed as a distance in the communication with the communication apparatus gets shorter, and after the distance in the communication with the communication apparatus becomes the shortest, employs the MCS at the time of the shortest distance regardless of whether the communication distance gets larger.

12. The wireless communication device of claim 10,
wherein after the connection process is completed with the communication apparatus, the processing circuitry employs an MCS for a highest transfer speed, and continuously employs the MCS until the communication with the communication apparatus is disconnected.

13. The wireless communication device of claim 1,
wherein when a signal is received from a communication device different from the communication apparatus while the intensity gets gradually lower after the data communication is started, the communication with the communication apparatus is disconnected without waiting for a result of sensing whether the difference becomes larger than the second threshold value.

14. The wireless communication device of claim 1,
wherein the communication with the communication apparatus at the point when the data communication is completed is disconnected, without waiting for a result of sensing whether the difference becomes larger than the second threshold value.

15. The wireless communication device of claim 1,
the processing circuitry further comprising:
an antenna to receive a radio signal transmitted from the communication apparatus through a radiated electromagnetic field.

16. The wireless communication device of claim 15,
wherein the radio signal has a frequency of 30 to 70 GHz.

17. A wireless communication method for performing close-range wireless communication between a fixed communication device installed at a fixed location and a mobile communication terminal, comprising:
measuring intensity of a signal received by one of the fixed communication device and the mobile communication terminal from the other;
sensing whether the intensity is equal to or greater than a first threshold value;
performing a connection process between the fixed communication device and the mobile communication terminal when it is sensed that the intensity is equal to or greater than the first threshold value, or when a predetermined signal is received from the communication apparatus;
performing, after the connection process is completed, data communication between the fixed communication device and the mobile communication terminal through close-range wireless communication;
updating the intensity to the first threshold value and sensing again whether the intensity is equal to or greater than the first threshold value, when the intensity measured by the intensity measuring unit becomes equal to or greater than the first threshold value after the data communication is started;
sensing whether a difference between the intensity and the first threshold value becomes larger than a second threshold value, due to a reduction in the intensity after the data communication is started; and
disconnecting the communication between the fixed communication device and the mobile communication terminal when it is sensed that the difference is larger than the second threshold value.

18. A wireless apparatus which wirelessly communicates with outside, comprising:
a wireless communication device which wirelessly communicates with the outside;
a processor to carry out data processing related to the wireless communication performed by the wireless communication device; and
a storage to store data related to the data processing,
wherein wireless communication device comprises processing circuitry,
the processing circuitry comprising:
to measure intensity of a signal received from a communication apparatus;
to sense whether the intensity is equal to or greater than a first threshold value;
to perform a connection process with the communication apparatus when being sensed that the intensity is equal to or greater than the first threshold value, or when a predetermined signal is received from the communication apparatus;
to perform, after the connection process is completed, data communication with the communication apparatus through close-range wireless communication;
to update the first threshold value to the intensity and make the first sensor proceed with its process, when the intensity becomes equal to or greater than the first threshold value after the data communication is started;
to sense whether a difference between the intensity and the first threshold value becomes larger than a second threshold value, due to a reduction in the intensity after the data communication is started; and
to disconnect the communication with the communication apparatus when being sensed that the difference is larger than the second threshold value.
